(19) United States
(12) Patent Application Publication
(10) Pub. No.: US 2008/0190595 A1
(43) Pub. Date: Aug. 14, 2008

(54) Method For Soldering Together Two Surfaces And A Device Comprising Two Surfaces Soldered Together

(76) Inventors: Per Sjodin, Lund (SE); Jens Rassmus, Malmo (SE)

Correspondence Address: FISH & RICHARDSON P.C., P.O. BOX 1022, MINNEAPOLIS, MN, 55440-1022, US

(21) Appl. No.: 11/912,702

(22) PCT Filed: May 19, 2006
(86) PCT No.: PCT/SE06/00576

§ 371 Date: Mar. 11, 2008

(51) Int. Cl. B23K 31/02; F28F 3/08

(52) U.S. Cl. 165/167; 228/183

(57) ABSTRACT

The invention relates to a method for connecting a first surface (20) to a second surface in a soldering process by use of a solder containing melting point reducer. The invention also relates to a device having a first surface (20) and a second surface, which surfaces are connected to one another by soldering with a solder containing melting point reducer. The first surface (20) borders on a structure (15a-f), part of which is brought into communication with the solder in order to transfer solder to the first surface. The structure (15a-f) is partly in communication with the solder, which solder is connected to the first surface (20).

### FIELD OF THE INVENTION

The present invention relates to a method for soldering together two surfaces according to the preamble of claim 1, and a device comprising two surfaces soldered together according to the preamble of claim 12.

### BACKGROUND TO THE INVENTION

Japanese patent specification JP 1254377 describes a soldered heat exchanger where a first surface which is to be soldered to a second surface is prepared beforehand with grooves containing solder.

Japanese patent specification JP 4363592 describes a soldered heat exchanger where solder in a soldering process is distributed between two bordering surfaces through the action of a capillary force.

International patent applications WO 02/38327 and WO 02/098600 describe an iron-based solder which during a soldering process diffuses with the surface which is coated with solder.

The disadvantage of JP 1254377 is that the grooves in the first surface are situated at a predetermined mutual distance. The distance between two grooves corresponds to a pitch of an undulated pattern of ridges and valleys in a bordering plate. This means that changing the adjacent plate's undulating pattern will cause a number of the ridges and valleys not to connect to the first surface. This is because a number of the ridges and valleys will not be “in phase” and will therefore not be situated over the grooves.

A further disadvantage of JP 1254377 is that the heat exchanger's aluminium components in the patent specification are intended to be soldered together by means of an aluminium-based solder. Such a solder forms a “traditional” solder seam between the surfaces which are soldered together. The soldering region after the soldering process comprises soldering surfaces and solder seams. After the soldering process the soldering region is not a homogeneous portion, since the solder only connects and does not diffuse into the surfaces. This contributes to the soldering region being weaker than the material portions which are not soldered.

The disadvantage of JP 4363592 is that solder is applied in edge regions on the heat exchanger, between two bordering portions which are to be soldered together. Capillary force helps solder to flow into gaps between bordering portions from the edge regions, thereby soldering them together. The portions which are to be soldered together are at varying mutual distances. Even if the variations are microscopic, this contributes to variation also in the capillary force within the various regions which are to be soldered. This means that, since the capillary force varies between different soldering regions, the solder's so-called flow distances between adjacent portions may also vary. There is therefore an obvious risk that there will between bordering portions be regions which do not become soldered. A further disadvantage of JP 4363592 is that the invention in the patent specification is intended to be soldered with a traditional solder whereby surfaces coated with solder do not diffuse. The result is a traditional solder seam which only connects two surfaces without diffusion having taken place. As in JP 1254377, the soldering region will therefore be weaker than a homogeneous material region.

The iron-based solder in WO 02/38327 and WO 02/098600 is a solder which during a soldering process diffuses with bordering surfaces which are to be soldered together. The composition of the solder is partly similar to the material composition of the bordering surfaces. The result is that in the soldering process with the solder according to WO 02/38327 and WO 02/098600 the solder and the soldering surfaces coincide, inter alia because of diffusion. The result is that the soldering region constitutes a partly homogeneous material with a material composition partly like the original surfaces.

### SUMMARY OF THE INVENTION

A stainless steel first planar surface is connected to a stainless steel second planar surface in a soldering process with an iron-based solder containing melting point reducer. The solder is applied to the first surface and, upon heating, connects the first surface to the second surface. During the soldering process, the solder diffuses with the adjacent surfaces so that they and the solder together constitute a partly homogeneous material region.

An object of the present invention is to provide a method for soldering together two planar surfaces by using an iron-based solder containing melting point reducer in such a way that the solder's capillary-induced positioning between the surfaces can be controlled.

A further object of the present invention is to provide a method for soldering together two planar surfaces by using an iron-based solder containing melting point reducer where the amount of solder needed for soldering together the surfaces is optimised.

The aforesaid and other objects are achieved according to the invention by providing the method described in the introduction with the characteristics indicated in claim 1.

An advantage afforded by a method according to the characterising part of claim 1 is that the necessary amount of solder can be optimised by placing the solder in a means which is adapted to holding the solder before the soldering process begins.

A further advantage afforded by a method according to the characterising part of claim 1 is that it becomes possible to position the solder, which is acted upon by capillary force between the surfaces, thereby making it possible to guide the solder to the regions which are to be soldered together.

A further advantage afforded by a method according to the characterising part of claim 1 is that the surface which is to be soldered will be defined by the position of the means. The means acts upon the capillary force in such a way that the capillary force is only active within a defined region between the surfaces. This makes it possible to control which surfaces are to be coated with solder.

Preferred embodiments of the method according to the invention are further provided with the characteristics indicated by subclaims 2-11.

According to an embodiment of the method according to the invention, part of the means is situated at a level which is different from the level where the first surface is situated. In a variant of said embodiment, the means is placed on the first surface. In a second variant of said embodiment, the means is a depression in the first surface. The means is placed in a predetermined position in or on the first surface. At the beginning of the soldering process, the means has the function of serving as a container for the solder. The fact that the means is positioned as may be desired thus makes it possible to control which surface the solder is to be applied to and soldered to.

According to an embodiment of the method according to the invention, the soldering process comprises a first step in which the solder is in the means in solid form, a second step in which an amount of the solder in the means changes from solid to viscous form, and a third step in which the viscous solder in the means is moved to a bordering surface by the action of capillary force. The reference to the solder being in “solid form” in the first step means that the components constituting the solder have not reacted with one another and that diffusion has not taken place. In this first step, instead of being in “solid form”, the solder may also be in powder or paste form. As previously mentioned, heating the solder causes some of the solder to change to viscous form.

According to an embodiment of the method according to the invention, the soldering process comprises a fourth step in which the solder is caused to almost completely leave the means so that the latter constitutes a void in the first surface. The capillary force acts upon the viscous solder by the solder being moved from the means to bordering surfaces. The result is the formation of a void after some of the solder has flowed away from the means.

According to an embodiment of the method according to the invention, the solder diffuses during the soldering process with the surface to which the solder is moved by capillarity. As previously mentioned, how far solder can flow between two bordering surfaces depends partly on the solder's setting time and the distance between the surfaces. Since the solder “sticks” to each surface which is to be soldered, the intermediate space between the surfaces becomes smaller. As the intermediate space becomes smaller while at the same time the solder sets, it also becomes more difficult for the solder to flow in between.

According to an embodiment of the method according to the invention, the soldering process is a metallic process and the respective surfaces for soldering take the form of metallic material. The solder in the process is iron-, copper- or nickel-based solder containing any of the components silicon (Si), boron (B), phosphorus (P), manganese (Mn), carbon (C) or hafnium (Hf). With advantage, the solder is iron-based solder similar to the solder described in international patent applications WO 02/38327 and WO 02/098600. Since the solder during the soldering process diffuses with bordering surfaces which are to be soldered together, the solder seam “disappears”. The solder seam together with the surfaces become a unity with only small changes in material composition.

According to an embodiment of the method according to the invention, the soldering process is effected at a partial pressure higher than the vapour pressure of the solder's component which has the highest vapour pressure.

According to an embodiment of the method according to the invention, the soldering process takes place in an atmosphere comprising an inert gas.

According to a variant of the embodiment, the soldering process takes place in an atmosphere comprising the gas argon.

A further object of the present invention is to provide a device comprising two surfaces which by a soldering process are soldered together by means of a solder containing melting point reducer, whereby the solder is placed, before the process, in a means associated with either of the surfaces.

The aforesaid and other objects are achieved according to the invention by providing the device described in the introduction with the features indicated by claim 12.

An advantage afforded by a device according to the characterising part of claim 12 is that the amount of solder needed for soldering a first surface to a second will be minimised. This is because the means for holding the solder is adapted to holding only a necessary volume of solder. The volume is adjusted to being sufficient to enable necessary solder contact between the surfaces to take place.

A further advantage afforded by a device according to the characterising part of claim 12 is that by positioning the means it becomes possible to control how the solder is to flow to desired soldering surfaces. The coating with solder of surfaces which are not to be soldered is thus avoided.

Preferred embodiments of the device according to the invention are further provided with the characteristics indicated by subclaims 13-29.

According to an embodiment of the device according to the invention, the means is placed in a region in the first surface which is planar and which comprises an edge portion. Placing the means in the first surface results in necessary solder contact with the second surface when the surfaces are abutted against one another. Heating during the soldering process will cause the solder in the means to become viscous. In this state, the solder is acted upon by a capillary force between the surfaces. The capillary force helps the solder to flow in between the surfaces in the region round the means via the edge portions of the means. Between the surfaces, the solder diffuses with the surfaces and solders them together. How far the solder flows in between the surfaces from the means depends partly on the size of the intermediate space between the surfaces, on the rate at which the viscous solder changes to solid state and on the rate at which the solder diffuses with the surfaces. The solder's viscosity depends on its material composition and the temperature to which the solder is subjected.

According to an embodiment of the device according to the invention, the means is placed in a planar region of said first surface, which region also comprises a port recess. The means extends wholly or partly round the port recess, which has the shape of a hole. The port recess is surrounded by an edge zone of the first surface, in which edge zone part of the means is placed. The port recess constitutes a communication channel whereby the first surface can communicate with the second surface. When a number of components comprising recesses are stacked on one another, the recesses coincide and constitute a channel. A joint thus occurs in the channel between each pair of components. Such a joint may give rise to leakage between the surfaces or to such phenomena as build-up of bacteria. To counteract such shortcomings, it is therefore necessary that the joint be filled with solder and be tight. It is advantageous if the inside of the channel is post-machined and smoothed by known grinding method so that the soldering region and the inside of the channel comprise no unevennesses. At the beginning of the soldering process, the solder will be in the means. Later in the process, when the solder becomes fluid, the capillary force will act upon the solder so that the solder moves from the means to bordering surfaces round the means. The fact that the means containing solder extends partly or wholly round the recesses ensures that the surfaces round the recesses become connected to one another.

According to an embodiment of the device according to the invention, the means is a depression in the first surface. The depression is a groove in the surface with two edges which border to the surface. The depression is with advantage situated so that it extends round a port recess. The means thus defines a soldering region delineated by the edge of the means and the edge of the port recess. This defined soldering region becomes coated with solder during the soldering process as a result of the capillary force acting upon the solder. The solder is with advantage placed not only in the means but also in the edge portion of the port recess. This makes it possible during the soldering process for solder, owing to the capillary force, to flow in between the surfaces from the means and from the edge portion of the port recess. The means in the surface “breaks” the action of the capillary force on the solder between the surfaces. This means that only the surfaces round the edge portions of the means which border to the surface are coated with solder. The means prevents uncontrolled flow of solder between the surfaces. The solder from the edge portions of the recess flows towards the means between the surfaces. This results in the solder meeting from two directions in the defined soldering region whereby the region becomes soldered.

According to an embodiment of the device according to the invention, the means completely surrounds the port recess in the first surface. There is thus assurance that the region round the port recess becomes coated with solder.

According to an embodiment of the device according to the invention, the means is an element placed between the first and second surfaces. The element comprises hollow space which in a first step of the soldering process contains solder. According to a first variant of said embodiment of the element, the element has a netlike structure. According to a second variant of said embodiment of the element, the element comprises one or more passages for communication between the first and second surfaces. The element is placed between the first and second surfaces. Contact is then effected between the element and the first and second surfaces respectively. During the soldering process, some of the solder changes from solid to viscous form. Viscous solder thus flows to adjacent surfaces. The surfaces are thus soldered to the element situated between them. An advantage of the element as above is that solder need only be applied to the side of the element which faces the first surface. As previously mentioned, the capillary force causes the solder to move. Some of the solder therefore flows through the element to the other side of the element and thereby solders together the surfaces and the element.

According to an embodiment of the device according to the invention, the solder in a first step of the soldering process is placed in the passages in the element. The element can thus be applied with solder before the soldering process begins. The advantage of this is that the element can be made elsewhere and thereafter be transferred to the location for soldering of the surfaces. Another advantage of the embodiment is that the amount of solder is controllable. Each surface which is to be soldered can therefore be soldered with the same amount of solder in a repetitive process. The result is an optimised soldering process.

According to an embodiment of the device according to the invention, the first and second surfaces are disposed in a heat exchanger. With advantage, the heat exchanger is disposed in a heat exchanger system. The first surface belongs to an adaptor plate on the heat exchanger. The second surface belongs to a sealing plate on the heat exchanger. The adaptor plate and the sealing plate each comprise at least one port recess, which port recesses together form part of a port channel when the adaptor plate and the sealing plate are placed on one another. The sealing plate is a plate in a plate stack in the heat exchanger which constitutes the outermost plate in the stack. The sealing plate comprises a surface which abuts against a heat transfer surface on an adjacent heat transfer plate. The plate package comprises between the plates a number of channels which accommodate a number of media. The media in adjacent channels are subject to temperature transfer through the heat transfer plate in a conventional manner. The sealing plate comprises an edge which partly extends down and over the edge portion of an adjacent heat transfer plate in the plate stack. The edge of the sealing plate seals against the adjacent heat transfer plate in such a way that a channel is formed between the plates. This channel either allows flow of a medium or is closed so that no flow takes place and the channel is therefore empty. To stiffen the sealing plate and the port regions, an adaptor plate is fitted to the sealing plate in the region over the ports. The adaptor plate is connected by one of its surfaces to the surface of the sealing plate which faces away from the centre of the plate stack. The surfaces are with advantage planar so that contact surfaces between the surfaces are maximised. As previously mentioned, the respective port recesses on the adaptor and sealing plates coincide, thereby forming a channel. On the inside of this port channel there is therefore a joint between the two plates. To prevent leakage at this joint from the port and out between the adaptor plate and the sealing plate, solder is applied round the port region between the plates. The solder is placed in a means which extends wholly or partly round the port region between the plates. During the soldering process, the solder in the means becomes viscous and flows out between the plates owing to the action of capillary force. On the surface regions between the adaptor and sealing plates outside the port regions, it is advantageous to place a number of means containing solder where soldering is considered necessary. A variant is to place the means in direct proximity to an edge region on either the adaptor or the sealing plate, whereby the edge portions round the plates will be soldered together. The advantage of solder being placed in the means is that it thus becomes possible to control the placing of the solder and the necessary volume/amount of the solder. This makes it possible to control which surfaces are to be soldered and which are not.

According to an embodiment of the device according to the invention, the first and second surfaces are disposed in a reactor system. Systems, e.g. reactor systems, where a process with various chemicals takes place involve high requirements for the materials of components. Components in reactor systems are in many cases connected to one another by welding, which is a time-consuming method and entails a plurality of complicated operations. Connecting such components by traditional soldering technology is another known technique but is less suitable, because the solder seam formed comprises in many cases a different material from that of the components. This may result in the solder seam being able to react chemically with process chemicals. Connecting the components with a solder according to international patent applications WO 02/38327 and WO 02/098600 results in a reactor system whose constituent parts are soldered together in such a way that solder seams and component materials coincide with one another. As the solder seam components partly correspond to those of bordering material, process chemicals will not affect the solder seam. A further advantage of using a solder according to the aforesaid patent applications is that the material stresses which would arise from welding of the above components are avoided.

According to an embodiment of the device according to the invention, the first and second surfaces are disposed in a pump system. A pump system may comprise a pump component, e.g. a pump housing, made a number of components which are joined together. Such components are normally joined together by welding. Welding the components together is time-consuming and complicated. Welding also creates stresses in the material which tend to cause weaknesses in and between the components. Soldering together the abutment surfaces of the components of the pump system with a solder according to international patent applications WO 02/38327 and WO 02/098600 avoids the aforesaid shortcomings. A further advantage is that since the solder diffuses into bordering connection surfaces, the components together constitute a homogeneous unity.

### BRIEF DESCRIPTION OF THE DRAWINGS

Preferred embodiments of the device according to the invention are described in more detail below with reference to the attached schematic drawings, which show only the parts which are necessary for understanding the invention.

FIG. 1 depicts a heat exchanger.

FIG. 2 depicts part of a cutaway according to section I of the heat exchanger according to FIG. 1.

FIG. 3 depicts an adaptor plate.

### DETAILED DESCRIPTION OF VARIOUS EMBODIMENTS OF THE INVENTION

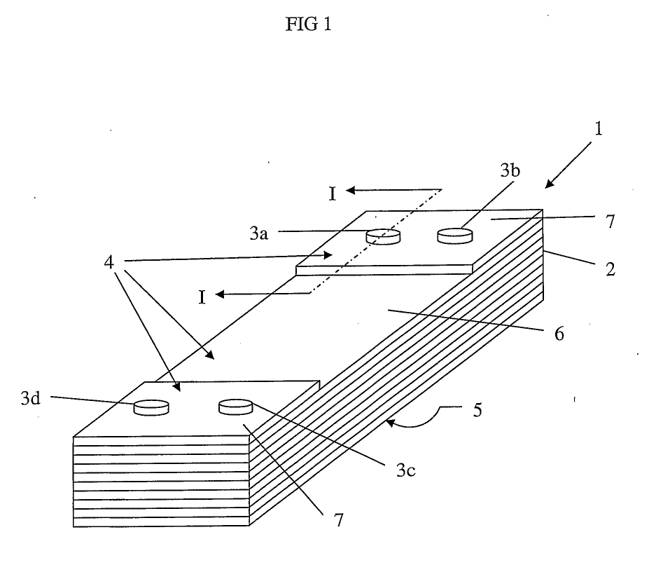

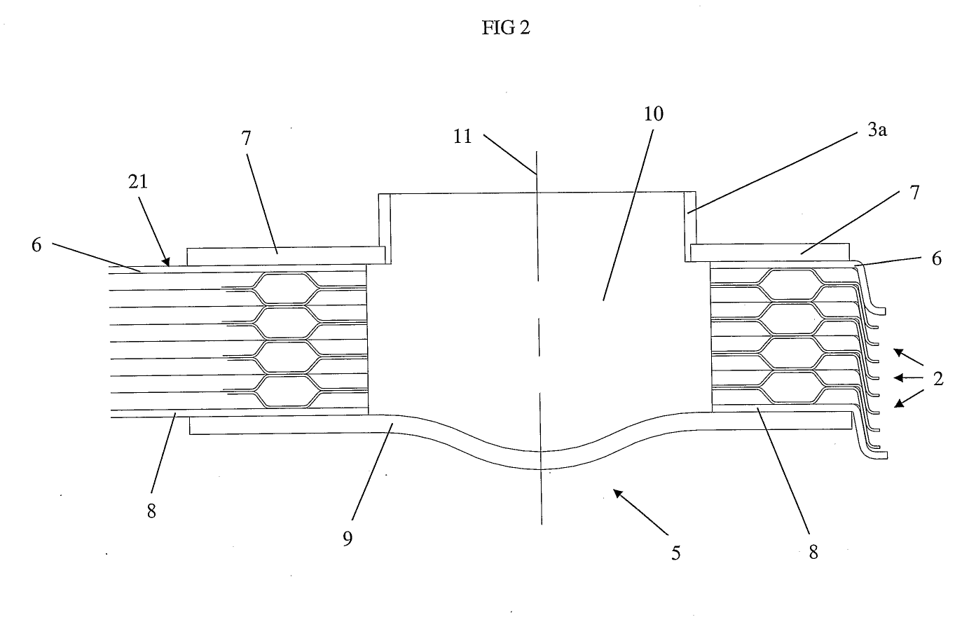

FIG. 1 depicts a heat exchanger (1) comprising a plate stack (2), a number of connections (3a-d), an upper portion (4) to which the connections (3a-d) are connected, and a lower portion (5). The plate stack (2) comprises a number of port channels (10, see FIG. 2). The upper portion (4) comprises a sealing plate (6) placed as one of two endplates to the plate stack (2). A first adaptor plate (7) is placed at the respective short end of the heat exchanger (1), on the side of the sealing plate (6) which does not abut against the plate stack (2). Said side comprises a surface hereinafter defined as the second surface (21, see FIG. 2). The adaptor plate (7) is placed in a region over the port channels (10) on the sealing plate (6). The connections (3a-d) to the port channels (10) of the heat exchanger (1) are connected to the adaptor plate (7) (see FIG. 2).

According to one embodiment, the sealing plate (6) is replaced by a frame plate (not depicted in the drawings). The differences between the sealing plate and the frame plate are that the sealing plate has an edge portion which extends to and over a bordering plate's edge portion on which it is placed. The sealing plate's edge portion seals against the bordering plate's edge portion, thereby forming an isolated space between the plates. In contrast, a frame plate is normally a planar plate connected to a bordering plate via the bordering plate's ridge pattern without sealing at the edges. The purpose of the sealing plate and the frame plate respectively is to increase the strength of the plate stack. A further purpose of a sealing plate or a frame plate is to create a planar surface to which the adaptor plate can be fastened.

At the lower portion (5) of the heat exchanger (1), a pressure plate (8) is connected to the plate stack (2), see FIG. 2. The pressure plate (8) is the second of two endplates to the plate stack (2). A second adaptor plate (9), also called a reinforcing plate, is placed in the region of the port channels (10) on the lower portion (5). The pressure plate (8) and the second adaptor plate (9) absorb some of the pressure created by a medium in the bordering port channels (10). The first and second adaptor plates (7 and 9 respectively) have with advantage a corresponding outer contour. The outer edge geometries of the adaptor plates (7 and 9) are with advantage placed in line above one another and parallel with a centreline (11) extending through the port channels (10).

According to another embodiment of a soldered heat exchanger (1), the sealing plate (6) is omitted (not shown in the drawings). The fact that the port portions are collared up makes it possible to omit the sealing or frame plate respectively, whereby the adaptor plate can be connected directly to the collared-up port portions. Collaring up of port portions means that each outermost plate's port portions in the plate stack (2) are so constructed as to be in one and the same plane in the plate pattern.

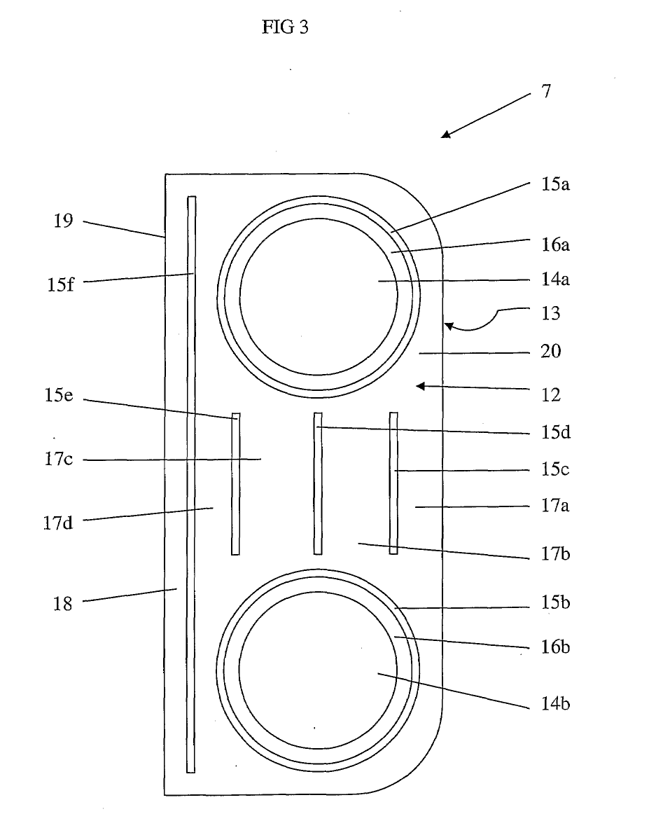

The first adaptor plate (7), see FIG. 3, comprises a first side (12) itself comprising a first surface (20), a second side (13) and port recesses (14a-b). A means (15a-b) in the form of a groove is placed round each of the port recesses (14a-b). Further means (15c-f) are placed in the first surface (20) on the first side (12) of the adaptor plate (7). The means (15a-f) is a groove in the first surface (12) made according to the state of the art. The groove has a cross-sectional shape allowing it to accommodate a medium, e.g. a solder. Examples of cross-sectional shapes other than traditional shapes with a bottom and walls include U, V and W shapes.

The means (15a-b), see FIG. 3, is placed in the preferred embodiment at a distance from the edge region of the port recess (14a-b). A defined first soldering region (16a-b) is formed between the means (15a-b) and said edge region. A second soldering region (17a-b) with means (15c-e) is situated between the port recesses (14a-b). A means (15f) is placed in a region along a first long side (19) of the adaptor plate (7). Said means extends parallel with and at distance from the edge region of the long side (19). A third soldering region (18) is defined in the space between the latter means (15f) and the edge region of the long side (19).

Before the commencement of a soldering process for soldering the adaptor plates (7 and 9) to the sealing plate (6, see FIG. 2) and the pressure plate (8) respectively, solder is placed in the means (15a-f). The solder is with advantage a similar solder in accordance with international patent applications WO 02/38327 and WO 02/098600. After the solder has been placed in the means (15a-f), the first adaptor plate (7) is placed with its first side (12) against the sealing plate (6) in the region over the latter's ports (3a-d). With advantage, the plates are fixed to one another by spot welding before the soldering process begins. When the plates have been fixed, further solder is applied to the edge regions between the sealing and adaptor plates (6 and 7). On the lower portion (5) of the heat exchanger (1), the adaptor plate (9) is fixed in a corresponding manner to the pressure plate (8).

During the soldering process, the solder is heated, whereby some of the solder changes from solid to viscous form. The viscous solder is acted upon by a capillary force whereby the solder endeavours to flow in between adjacent surfaces (20 and 21). The solder endeavours to spread out in possible directions between adjacent planar surfaces. Where surface planarity is disrupted, e.g. by a means (15a-f) in the surface, the solder is prevented from continuing to spread out in said direction. A common problem in soldering between two surfaces is that the capillary force causes the solder to flow from an intended soldering portion to another portion, or that the solder builds up at a point. The fact that the soldering surface in the preferred embodiment comprises means (15a-f) therefore makes it possible to guide solder to portions which are to be soldered together. The solder's surface tension causes the solder as far as possible to endeavour to keep together. The surface tension also causes some of the solder to endeavour to connect to or have contact with something, e.g. an edge of the means (15a-f). The surfaces round the means (15a-f) thus become coated with solder and thereby connect bordering surfaces to one another. As a result, the solder endeavours to spread out away from the respective edge portions, whereby the surface regions round the means (15a-f) become coated with solder. By positioning of the means (15a-f) it therefore becomes possible to control which surfaces are to be soldered together.

As previously mentioned, solder is applied in the edge portions between the adaptor plates (7 and 9 respectively) and the bordering plates (6 and 8 respectively). The solder therefore flows in between said plates. The surfaces in the soldering regions (16-18) thus become coated with solder both away from the means (15a-f) and away from the edge portions.

In the soldering process, diffusion takes place between solder and soldering surfaces (this is not-depicted in the drawings). As a result, solder and bordering surfaces coincide with one another and form a rather homogeneous material region.

After the soldering process, with attendant diffusion, there is in the means a void, not depicted in the drawings. The void is formed in the means by the solder flowing from the means to bordering surfaces. As a result, the means becomes partly empty of solder.

The invention is not limited to the embodiments referred to but may be varied and modified within the scopes of the claims set out below, as has been partly described above.

What is claimed is:

1-29. (canceled)

30. A method for connecting a first surface (20) to a second surface (21) in a soldering process by means of a solder containing melting point reducer, wherein the first surface (20) borders on a means (15a-f), part of which is placed in communication with the solder in order to transfer solder to the first surface.

31. A method according to claim 30, wherein part of the means (15a-f) is placed at a level which is different from the level where the first surface (20) is situated.

32. A method according to claim 30, wherein the means (15a-f) is placed on the first surface.

33. A method according to claim 30, wherein the soldering process comprises a first step in which the solder is the means (15a-f) in solid form, a second step in which an amount of the solder means (15a-f) changes from solid to viscous form, and a third step in which the viscous solder in the means (15a-f) is moved to a bordering surface by the action of capillary force.

34. A method according to claim 33, wherein the soldering process comprises a fourth step in which the solder is caused to almost completely leave the means (15a-f) so that the latter constitutes a void in the first surface (20).

35. A method according to claim 33, wherein the solder during the soldering process diffuses with the surface to which the solder is moved by capillary action.

36. A method according to claim 30, wherein the soldering process is a metallic process and respective surfaces for soldering take the form of a metal-like material.

37. A method according to claim 30, wherein the solder is an iron-, copper- or nickel-based solder.

38. A device comprising a first surface (20) and a second surface (21), which surfaces are connected to one another by soldering with a solder containing melting point reducer wherein the first surface (20) borders on a means (15a-f), which means (15a-f) is partly in communication with the solder, which solder is connected to the first surface (20).

39. A device according to claim 38, wherein the means (15a-f) is placed in a region in the first surface (20) which is planar, which region comprises an edge portion.

40. A device according to claim 39, wherein the means (15a-f) is placed in the planar region of said first surface (20), which region also comprises a port recess (14a-b).

41. A device according to claim 40, wherein the means (15a-f) extends wholly or partly round the port recess (14a-b), which has the shape of a hole.

42. A device according to claim 41, wherein an edge zone of the first surface (20) surrounds the port recess (14a-b), in which edge zone part of the means (15a-f) is placed.

43. A device according to claim 42, wherein the means (15a-f) is a depression in the first surface (20).

44. A device according to claim 40, wherein the means (15a-f) completely surrounds the port recess (14a-b) in the first surface (20).

45. A device according to claim 38, wherein the means (15a-f) is an element placed between the first and second surfaces (20 and 21).

46. A device according to claim 45, wherein the element comprises a hollow space which in a first step of the soldering process contains solder.

47. A device according to claim 45, wherein the element has a netlike structure.

48. A device according to claim 45, wherein the element comprises one or more passages for communication between the first and second surfaces (20 and 21).

49. A device according to claim 48, wherein in a first step of the soldering process the solder is placed in the passages in the element.

50. A device according to claim 38, wherein the first and second surfaces (20 and 21) are disposed in a heat exchanger (1).

51. A device according to claim 50, wherein the first surface (20) belongs to an adaptor plate (7 and 9 respectively) on the heat exchanger (1).

52. A device according to claim 50, wherein the second surface (21) belongs to a sealing plate (6) on the heat exchanger (1).

53. A device according to claim 51, wherein the adaptor plate (7 and 9 respectively) and the sealing plate (6) each comprise at least one port recess (14a-b), which port recesses (14a-b) together form part of a port channel (10) when the adaptor plate (7 and 9 respectively) and the sealing plate (6) are placed on one another.

54. A device according to claim 52, wherein the adaptor plate (7 and 9 respectively) and the sealing plate (6) each comprise at least one port recess (14a-b), which port recesses (14a-b) together form part of a port channel (10) when the adaptor plate (7 and 9 respectively) and the sealing plate (6) are placed on one another.
